(19) United States
(12) Patent Application Publication
(10) Pub. No.: US 2005/0084266 A1
(43) Pub. Date: Apr. 21, 2005

(54) Method for optical coding, optical corder and ocdma network architecture

(76) Inventors: Olli-Pekka Pohjola, Helsinki (FI); Makku Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/466,100

(22) PCT Filed: Jan. 13, 2001
(86) PCT No.: PCT/EP01/00373

(51) Int. Cl. H04J 14/02

(52) U.S. Cl. 398/77

(57) ABSTRACT

The invention relates to a method for optical coding of a broadband signal, to an optical coder. In order to enable an efficient increase in the number of codes for an OCDMA system, the method comprises coding the signal by frequency-hopping and coding the frequency-hopping coded signal temporally or coding the signal temporally and coding the temporally coded signal by frequency-hopping. The proposed optical coder 10 comprises corresponding means 20, 30. The invention relates equally to a network architecture for optical coding of broadband signals originating from a plurality of users 50 or for optical decoding of an encoded broadband signal destined for a plurality of users 50 with distributed means for frequency-hopping and temporal coding.

### FIELD OF THE INVENTION

The invention relates to a method for optical coding of a broadband signal, to an optical coder and to an OCDMA network architecture for optical coding of broadband signals originating from a plurality of users or for optical decoding of an encoded broadband signal destined for a plurality of users.

### BACKGROUND OF THE INVENTION

Optical fibres allow a transmission of signals with a huge bandwidth. In order to be able to share this bandwidth for several connections without the need for complicated electronic signal processing, optical code-division multiple access (OCDMA) to the optical fibres was introduced. The most common OCDMA systems are coherent or incoherent, synchronous or asynchronous, based on temporal or spectral coding or on frequency-hopping, which constitutes a combination of temporal and spectral coding.

In OCDMA systems, the number of users that can be supported depends on the length and the efficiency of the codes with which signals are coded for transmission. Therefore, the kind of codes that is provided for coding constitutes an important aspect in such a system.

In temporal coding a short light pulse coming from a transmitter is applied to a group of parallel or serial optical delay lines, which divide the pulse into a temporal chip sequence. Temporal codes can be extended by increasing the number of time slots in a bit interval. More time slots means that the chip rate must be higher and/or the pulses shorter. This causes problems in pulse generation and signal detection.

Alternatively to temporal coding with optical delay lines, it is known to employ a coherent temporal coding. Coherent temporal coding is based on the coherent interference of time delayed chips generated out of one pulse. The chip sequence can be generated and decoded either by a serial ladder-structure of tunable delays or by a parallel delay structure where the phase of each chip is shifted by 0 or π according to the code. In the case of code matching in decoding, constructive interference occurs and a high autocorrelation peak is obtained, whereas in case of code mismatch destructive interference will reduce the crosstalk. However, in coherent coding, the chip rate and the lengths of pulses is restricted by the physical limits in the used components, e.g. the maximum density of gratings before the gratings are connected to each other in case fibre Bragg gratings are employed for coherent temporal coding.

In frequency-hopping coding, a short broadband light pulse is modified in the time and the frequency domain. In an encoder, a pulse is first divided to frequency bins, e.g. by interleavers. Then, each frequency bin is individually delayed according to the code of the frequency-hopping coder. In frequency-hopping coding, the codes can be extended by increasing the number of frequency bins into which an incoming broadband pulse is divided. To this end, the frequency range of the incoming broadband pulse can be broadened or the created frequency bins can be narrowed. Fibre dispersion limits the former solution and component technology the latter. Moreover, coders become more expensive when the number of frequency bins is increased.

### SUMMARY OF THE INVENTION

It is an object of the invention to provide a method and an optical coder for allowing an efficient increase in the number of codes for an OCDMA system.

On the one hand, this object is reached by a method for optical coding of a broadband signal comprising coding the signal by frequency-hopping and coding the frequency-hopping coded signal temporally.

The object is equally reached by a reversed method for optical coding of a broadband signal comprising coding the signal temporally and coding the temporally coded signal by frequency-hopping.

On the other hand, the object is reached by an optical coder for coding of a broadband signal comprising means for coding a broadband signal by frequency-hopping and means for temporal coding of broadband signals, both means being connected to each other.

Finally, the object is reached by an OCDMA network architecture for optical encoding of broadband signals originating from a plurality of users, and for optical decoding of an encoded broadband signal destined for a plurality of users.

The network architecture according to the invention for encoding comprises between the plurality of users and an optical transmission fibre arranged in any order:
means for temporal coding of optical signals originating from the plurality of users and for forwarding the temporally coded signals in direction of the optical transmission fibre;
means for frequency hopping coding of optical signals originating from the plurality of users and for forwarding the frequency hopping coded signals in direction of the optical transmission fibre; and
means for wavelength division multiplexing of optical signals originating from the plurality of users and for forwarding the multiplexed signals in direction of the optical transmission fibre.

Correspondingly, the network architecture according to the invention for decoding comprising arranged in any order between an optical transmission fibre supplying the encoded broadband signal and the plurality of users:
means for temporal decoding of the signals originating from the optical transmission fibre and for forwarding the temporally decoded signals in direction of the plurality of users;
means for frequency hopping decoding of the signals originating from the optical transmission fibre and for forwarding the frequency hopping decoded signals in direction of the plurality of users; and
means for wavelength division demultiplexing of the signals originating from the optical transmission fibre and for forwarding the demultiplexed signals in direction of the plurality of users.

With the methods, the optical coder and the network architectures of the invention it is proposed to employ a combination of frequency-hopping coding and temporal coding for the coding of signals transmitted in an optical fibre network. The combination of the frequency-hopping coding and the temporal coding define the complete code applied to the respective signal.

Compared to pure frequency-hopping coding, the proposed non-blocking frequency-hopping coding requires less frequency bins and therefor lower incident costs. Compared to pure temporal coding the chip rate is lower, which leads to an easier pulse generation and signal detection.

The proposed coder and the proposed method can be realised strictly non-blocking 2-dimensional, since there is no restriction regarding the number of chips per frequency bin in the frequency-hopping coding, and same time slot can be used for many signals. In contrast, pure temporal coding uses only one or no pulse with an always equal frequency per time slot, and pure frequency-hopping coding uses one or no frequency bin of a signal per time slot. Therefore, with non-blocking frequency-hopping coding it is easier to find the optimum between the chip rate and the number of frequency bins to be used, because the number of available codes is larger.

Cascaded temporal and frequency-hopping coders also give new opportunities to OCDMA network architectures. Dividing the coding in a network architecture into two parts increases the multiplexing stages in the network. The network becomes thus more flexible and scalable so that it can support various logical topologies and bit rates. Moreover, in known frequency hopping OCDMA systems, every user typically must have a unique coder. This causes big problems in logistics, as the number of users can be very high and frequency hopping coders are rather expensive compared to temporal coders. With the proposed divided coding, one frequency hopping coder can be used for a plurality of users, the individual coding being guaranteed by the temporal coders assigned to each user.

The term coding or coder is to be understood to include equally encoding or encoder and decoding or decoder, since the difference consists only in the code that is applied to the respective signal.

Preferred embodiments of the invention become apparent from the subclaims.

The proposed non-blocking coder can be composed of pure means for frequency-hopping coding and pure means for temporal coding. In the easiest case, the single output of a frequency-hopping coder is connected to the single input of a temporal coder or the other way around.

The specific choice of the code for the frequency-hopping coder and the code for the temporal coder defines the complete code applied to a signal. If wavelength division multiplexing (WDM) is used in addition, i.e. for different original signals different WDM channels with restricted bandwidths are transmitted, the combination of the WDM channel, the frequency hopping code and the temporal code has to be unique. A network making use of such coders becomes more flexible, since e.g. the employed bit rates can changed by changing only the temporal coder.

The means for frequency-hopping coding and the means for temporal coding can be of any suitable known kind.

The means for frequency-hopping coding can be periodic or non-periodic. Whether a periodic frequency-hopping coding is required depends on the employed network architecture as specified below. Periodicity means that the coder can code more than one WDM channel simultaneously. This is typically the case in non-coherent temporal coding, but not always in coherent temporal coding or in frequency-hopping. Means for periodic frequency-hopping coding can be designed to code one or more, but not necessarily all wavelength divisional multiplexing channels destined to be provided to them. Moreover, the means for frequency-hopping coding can e.g. be based on arrayed waveguide grating (AWG), wavelength division multiplexing, interleavers, or fibre Bragg gratings (FBG).

Interleaver technology is an increasingly common solution for achieving narrow channel spacing of 50 GHz and narrower. Basically, two separate frequency sets with twice the channel target spacing are combined or separated by an interleaver to cover the entire operating window by interleaving them. Interleavers can be cascaded by providing one interleaver for the first stage and in each following stage two interleavers for each interleaver of the previous stage. With such a cascade, a plurality of frequency sets can be combined or separated in a way that the input channel spacing of one stage is always double compared to the previous stage. This means that the channel spacing in the output of the nth stage is 2n times the input channel spacing of the interleaver of the first stage. The use of interleavers in frequency-hopping coders is proposed in an application of the same filing date by the same applicant, titled “OCDMA network architectures, optical coders and methods for optical coding”, which is incorporated by reference herewith. Interleavers are typically based on different kinds of interferometers, like Mach-Zehnder, Michelson, etc., but also fiber Bragg grating structures can be used.

The means for temporal coding can in particular be parallel or serial. They can also use multiple bit period temporal coding, as described in another application of the same filing date by the same applicant, titled “Method and optical coder for coding a signal in an optical fibre network”, which is also incorporated by reference herewith.

In a preferred embodiment, the frequency-hopping coding and the temporal coding are not carried out by completely separated means. Rather, the means for temporal coding are integrated in the means for frequency-hopping coding. More specifically, a corresponding optical coder comprises means for splitting the broadband signal into at least two frequency bins, which is a means included in known pure frequency-hopping coders. Further, the coder comprises means for coding each frequency bin individually temporally. Such means are means included in known pure temporal coders. Finally, means are provided for combining the temporally coded frequency bins to a single signal again, which is again a means included in known pure frequency-hopping coders, except that in those, the frequency bins that are to be combined have not been temporally coded. With such a coder and the corresponding method, the frequency bins generated in a frequency-hopping coder anyhow can be coded in addition temporally, enabling an even more flexible generation of codes.

The means for temporal coding in this example can comprise in particular means for splitting each frequency bin into at least two identical frequency bins, means for delaying each identical frequency bin individually temporally and means for combining each pair of individually delayed identical frequency bins again. Preferably, before splitting for temporal coding, at least some of the frequency bins are temporally delayed. On the one hand, this completes the frequency-hopping part of the combined coder to a complete frequency-hopping coder as known from the state of the art, which requires a delay of the frequency bins for frequency hopping. On the other hand, the delay lines in the temporal coders can be reduced to a minimum, if the delay common to both frequency bins of a pair of frequency bins is combined in the frequency-hopping part of the coder.

Just like the splitting for frequency-hopping coding, the combining of temporally coded signals can be achieved with any suitable components, like couplers or wavelength selective components as e.g. AWG, WDM components or interleavers.

As an alternative to providing separate means for combining the temporally coded frequency bins again, reflection means can be provided for reflecting the temporally coded signals leaving the means for temporal coding back via said means to the means for splitting the original signal into frequency bins. The means for splitting can then be used at the same time as means for combining the temporally coded frequency bins to a single signal.

It was already mentioned that temporal coding or the means for temporal coding of a coder of the invention can be parallel or serial. In addition, the temporal coding or the means for temporal coding can be incoherent or coherent, and period or non-periodic.

Signal detection in OCDMA systems is usually limited by multiple access interference (MAI) which is usually proportional to number of users.

The proposed non-blocking coding spreads the MAI more evenly over the bit period, but it does not reduce it. If, however, the temporal coding of the proposed non-blocking frequency-hopping coding is in addition realised as coherent temporal coding, the use of bipolar codes in temporal coding is enabled. With bipolar codes, the length of codes can be increased and the interference from other users can be reduced.

Coherent temporal coders can be based on cascaded fiber Bragg gratings whose amplitude and relative phase properties compose the code. For example, in addition to temporally delaying signals, the phase φᵢ and/or the amplitude Aᵢ of the signals can be changed. Coherent temporal coding based on segmented fibre gratings has been described for example in “Demonstration of All-Fiber Sparse Lightwave CDMA Based on Temporal Phase Encoding” by A. Grunnet-Jepsen, A. E. Johnson, E. S. Maniloff, T. W. Mossberg, M. J. Munroe and J. N. Sweetser; IEEE Photonics Technology Letters, Vol. 11, No. 10, October 1999.

As an alternative to fibre Bragg gratings, coherent temporal coders employed in the non-blocking coder of the invention can be of a lattice type, or make use of superstructured fiber gratings.

If the coherent temporal coding is to be combined with the frequency-hopping coding in a way that the coherent temporal coding occurs inside each frequency bin, the frequency-hopping coders used should be of transmission type. The coherent temporal coders, on the other hand, have to be designed to be able to code coherently inside the frequency bins generated in the frequency-hopping coder. With such a coherent coding within the frequency bins, the interference from other users is decreased even further. On the other hand, the number of users can be higher compared to pure coherent coding, since the codes can easier be made longer.

Advantageously, periodic coherent temporal coders are used, which allows the same coherent frequency-hopping coder to be used in several WDM channels.

Coherent coders are typically wavelength dependent, i.e. they code only within a certain WDM channel, by reflecting a signals of the corresponding wavelength back with different amplitudes and phases. The coder passes other WDM channels through. When cascading such coders for different WDM channels, many channels can be coded with a single coder, even though different frequency-bins can not be on the same time slot. Preferably, delay lines are provided between the coders. These coders can be made with fibre Bragg grating technology with a connection to a single fibre. One advantage is that only one direction selective component like a circulator is needed.

For a periodic coherent coder, the signals of a first WDM channel are reflected from first coder, and the signals of a second WDM channel are reflected from a second coder, and so on. The order of coders can be what ever. In addition, several coherent coders can be employed for the different frequency bins of each WDM channel with delay lines in between at least some of the coherent coders for one WDM channel.

In the network architectures according to the invention, the arrangement of the means for temporal coding (TC), frequency hopping coding (FH) and wavelength division multiplexing (WDM) is arbitrary for both, encoding and decoding. Possible are the following orders between the users and a transmission fibre:
User-TC (single wavelength or periodic), WDM, FH (periodic)-Fibre;
User-TC (single wavelength or periodic)-FH (single wavelength or periodic)-WDM-Fibre;
User-FH (single wavelength or periodic)-WDM-TC (periodic)-Fibre;
User-FH (single wavelength or periodic)-TC (single wavelength or periodic)-WDM-Fibre;
User-WDM-FH (periodic)-TC (periodic)-Fibre; and
User-WDM-TC (periodic)-FH (periodic)-Fibre.

Coders that are arranged between the transmission fibre and the means for WDM multiplexing have to be periodic or at least to be able to code within each passband of WDM. This is indicated in brackets behind the respective coders by the single term “periodic”. All other coders can alternatively be designed to code a single wavelength.

The different possibilities for arranging the components of a network architecture might be usefull when each stage can multiplex different number of signals, so the network architecture can be very flexible. The number of different components in different network architectures changes, although the total number of components is constant.

The proposed architectures can be used as an upgrade to existing WDM networks. This would mean that an existing WDM component is used as one of the WDM components of the network. Equally, several WDM components can be combined to a single fibre. When the network has to be upgraded in order to support more users, temporal and frequency hopping coders are inserted to the network.

Major advantage of such an upgrade is that the employed WDM components are similar. In known WDM upgrades, the channel spacing of the components is the same, but the centre frequencies are shifted.

For the first mentioned arrangement of components in a network architecture according to the invention, User-TC-WDM-FH-Fibre, the network architecture preferably comprises more specifically: means for temporal coding for each user; at least one means for multiplexing the temporally coded signals of at least part of the users with different frequency bands to a single signal; and assigned to each means for multiplexing a means for periodic frequency hopping coding for coding the respective multiplexed signal with a different code.

A corresponding network architecture for decoding comprises at least one means for periodic frequency hopping coding for decoding the encoded broadband signal by frequency hopping; assigned to each means for periodic frequency hopping coding a means for demultiplexing the frequency-hopping decoded signal into at least two signals with different frequency bands; and means for temporal decoding of each signal output by the means for demultiplexing, and for forwarding each temporally decoded signal to one of the users.

In this network architecture, the division of coding into a frequency hopping part and a temporal coding part enables a flexible use of the expensive frequency hopping coders. In one extreme, temporal coding is not applied at all, thus maximising the bit rate for a single user. Increasing of the number of temporal codes increases the number of users that can be supported, but decreases the bit rate for each user. An increasing number of temporal coders increases the cost of network, but temporal coders are rather inexpensive.

In a further preferred embodiment of the latter network architecture, the at least one means for multiplexing comprises a plurality of means for multiplexing each the temporally coded signals of a different group of users. Correspondingly, the at least one means for periodic frequency hopping coding comprises a separate means for periodic frequency hopping coding for each means for multiplexing. Further means are provided for coupling the plurality of frequency hopping coded signals to a single signal are provided.

Additionally, the temporally coded signals of at least two of the users are preferably coupled before multiplexing to a single signal. If the means for temporal coding for those users comprise different codes, the original signals can be distinguished in the combined signal.

A corresponding network for decoding comprises the same means used in reversed direction, i.e., couplers are used as splitters and means for multiplexing as means for demultiplexing.

By varying the code combinations, the number of users in the WDM channels may be different and the users may have different bit rates.

It is also possible to mix a network architecture according to the invention with other network architectures, e.g. one of the network architectures described in the above cited document “Optical coder, OCDMA network architecture, and method for optical coding”.

Such mixed network architectures allow a very flexible network design.

The optical coders and the network architectures according to the invention can be designed to be suitable for a bi-directional use. That means, in one direction, they can be used for encoding signals and in the opposite direction, they can be used for decoding signals.

A preferred use of the optical coder, the OCDMA network architectures and the method of the invention can be seen in IP (internet protocol) over fibre systems, though the use is not limited to such systems.

### BRIEF DESCRIPTION OF THE FIGURES

In the following, the invention is explained in more detail with reference to drawings, of which

FIG. 1 schematically shows a first embodiment of an encoder according to the invention;

FIG. 2 schematically shows a first embodiment of an encoder according to the invention;

FIG. 3 illustrates a possibility for separating a broadband light signal in a coder according to the invention;

FIG. 4 schematically shows a third embodiment of an encoder according to the invention;

FIG. 5 schematically illustrates coherent coding with FBG technology;

FIG. 6 schematically shows a fourth embodiment of an encoder according to the invention;

FIG. 7 schematically shows a fifth embodiment of a coder according to the invention;

FIG. 8 schematically shows a sixth embodiment of a coder according to the invention;

FIG. 9 schematically shows an embodiment of a network architecture according to the invention; and

FIG. 10 schematically shows a mixed network architecture according to the invention.

### DETAILED DESCRIPTION OF THE INVENTION

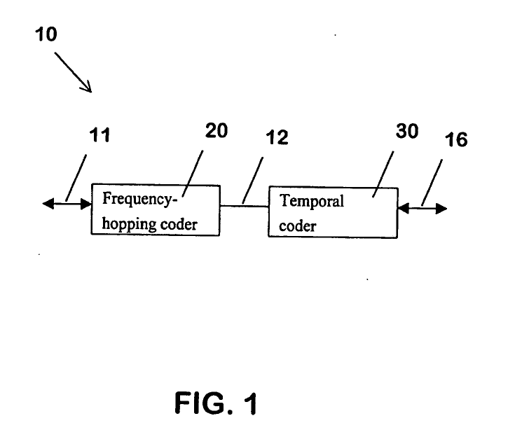

A first embodiment of an optical coder according to the invention is illustrated in FIG. 1. The non-blocking coder 10 is composed of a pure frequency hopping coder 20 and a pure temporal coder 30, which are connected to each other via an optical fibre 12. Both coders have additionally and in- and output connected to an optical fibre 11, 13. As frequency-hopping coder 20 and as temporal coder 30, any known kind of corresponding coder can be used. The frequency hopping coder 20 can e.g. be based on AWG, FBG, interleavers, WDM components, etc. The temporal coder 30 can comprise for example parallel or serial delay lines and can in particular also be a coherent temporal coder.

A broadband pulse entering the coder 10 via fibre 11 is first divided in the frequency-hopping coder 20 into frequency bins and each bin is delayed individually according to the code of the frequency-hopping coder 20. After the frequency bins have been combined again, a single, frequency-hopping coded signal is output by the frequency-hopping coder 20. This signal is then input via fibre 12 to the temporal coder 30, in which a group of optical delay lines spreads the frequency bins of the combined signal commonly into a temporal chip sequence, each chip being distributed over the frequencies of one of the frequency bins. The temporal chip sequence is output to fibre 13.

A broadband pulse entering the coder 10 via fibre 13 is first applied to a group of optical delay lines of the temporal coder 30 dividing the pulse into a single temporal chip sequence, the chips being distributed over the whole frequency range of the broadband signal. This sequence is then provided via fibre 12 to the frequency hopping coder 20, which creates several frequency bins out of each temporal chip and delays the frequency bins originating from one temporal chip individually before combining and outputting them to fibre 11.

The resulting signal is the same in both directions.

The complete coder 10 enables in both directions more codes than pure frequency-hopping coding, since an arbitrary temporal coding is superposed on the frequency-hopping coded or to be frequency-hopping coded signals and the total code can be easily changed by exchanging only the less expensive temporal coder 30. However, each frequency bin is coded temporally with the same code.

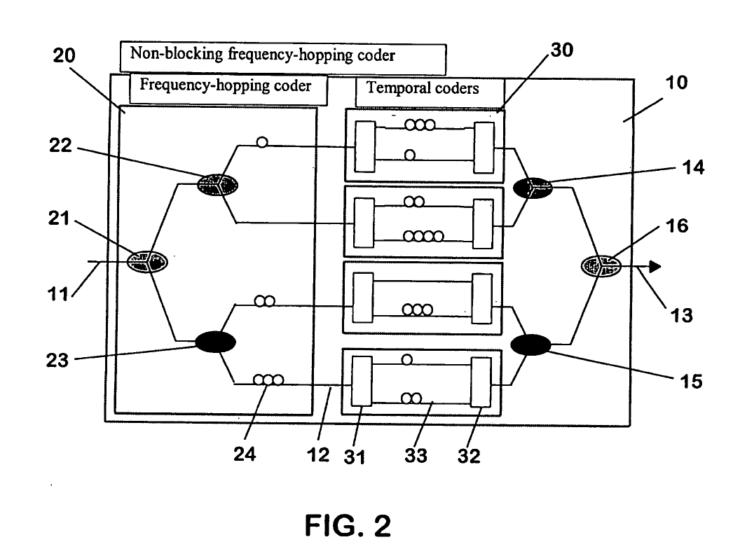

Therefore, FIG. 2 presents a second embodiment of a coder 10 according to the invention, which allows in addition a different temporal coding of different frequency bins of the same signal. Corresponding components were assigned the same reference number.

This non-blocking coder 10 comprises a frequency-hopping coder part 20 and four temporal coders 30.

The frequency-hopping coder 20 comprises a first interleaver 21 connected on the one hand via the input of the complete coder 10 to an optical fibre 11 and on the other hand to the respective input of two further interleavers 22, 23. Together, the three interleavers 21-23 form a cascade of interleavers. The two further interleavers 22, 23 have two outputs respectively, each connected to one of four delay lines 24 of different lengths. The different lengths are symbolised by different numbers of small loops integrated in the lines 24. The opposite ends of those delay lines 24 form four outputs of the frequency-hopping coder 20, each connected via an optical fibre 12 to the input of a different one of the four temporal coders 30.

Each of the temporal coders 30 has a splitter 31 connected to its input and a coupler 32 connected to its output. Between two outputs of each splitter 31 and two inputs of each coupler 32, delay lines 33 of different lengths are provided.

The outputs of two of the temporal coders 30 are connected to a fourth interleaver 14 and the outputs of the other two of the temporal coders 30 to a fifth interleaver 15. The fourth and the fifth interleaver 14, 15 are connected moreover to a sixth interleaver 16, forming thus a second cascade of interleavers. The output of the sixth interleaver 16, finally, is connected to the output of the complete coder 10 leading to an optical transmission fibre 13.

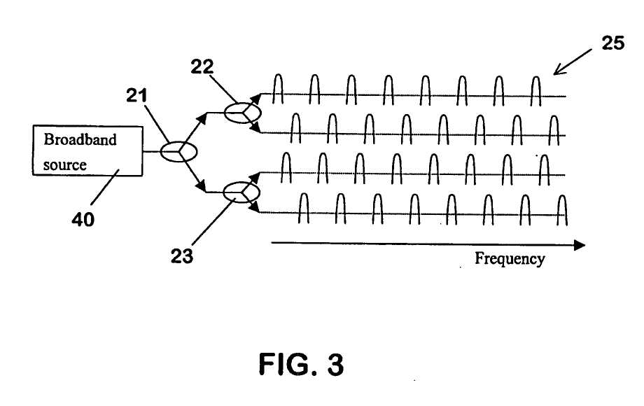

A broadband signal entering the complete non-blocking coder 10 and therewith the integrated frequency-hopping coder 20 via the optical fibre 11 is first split up into four interleaved frequency sets by the interleavers 21-23 of the frequency hopping coder 20 as illustrated schematically in FIG. 3.

FIG. 3 shows the same cascade of interleavers 21-23, which is connected at its input at the first interleaver 21 to a broadband source 40. The frequency sets 25 output by the respective two outputs of the second and the third interleaver 22, 23 are illustrated on the right hand side. A broadband signal output by the broadband source 40 and entering the cascade is split by the first interleaver 21 into two separate but interleaved frequency sets with twice the channel target of the original broadband signal. The second and the third interleaver 22, 23 forming the second stage of the cascade each receives one of the frequency sets and separates it again into two further, equally interleaved frequency sets 25. Because of the interleaving splitting, each frequency set 25 covers the complete operation window of the original broadband signal. The frequency bin chips of each of the four frequency sets 25 are depicted in FIG. 3 with increasing frequency to the right, each set 25 associated to the respective output of the cascade. The channel spacing of the resulting frequency sets 25 is four times the channel spacing SP of the signal entering the first interleaver 21.

Each of the four frequency sets is then individually delayed by one of the delay lines 24 of the frequency-hopping coder 20 of FIG. 2 and forwarded via one of the connection fibres 12 to the temporal coder 30 assigned to the respective delay line 24.

In the temporal coders 30, the received commonly delayed frequency set is split by the splitter 31 into a pair of two identical frequency sets, each being fed to a different one of the two parallel optical delay lines 33. Both identical frequency sets are then delayed individually by the respective delay line 33 and combined again by the coupler 32 of the respective temporal coder 30. As a result of the coding in the temporal coder 30, for each frequency of a frequency set, there are now two chips at different temporal positions.

The frequency sets output by the four temporal coders 30 are combined again by the second cascade of interleavers 14-16, first into two sets by the fourth and the fifth interleaver 14, 15 and then into a single set by the sixth interleaver 16 and fed to the optical fibre 13.

The temporally coded frequency sets could equally be combined to one fibre by couplers or other wavelength selective components, like AWG or WDM components. The described coder 10 is a strictly non-blocking 2-dimensional coder, since there is no restriction regarding the number of chips per frequency bin and the same time slot can be used in many frequency bins.

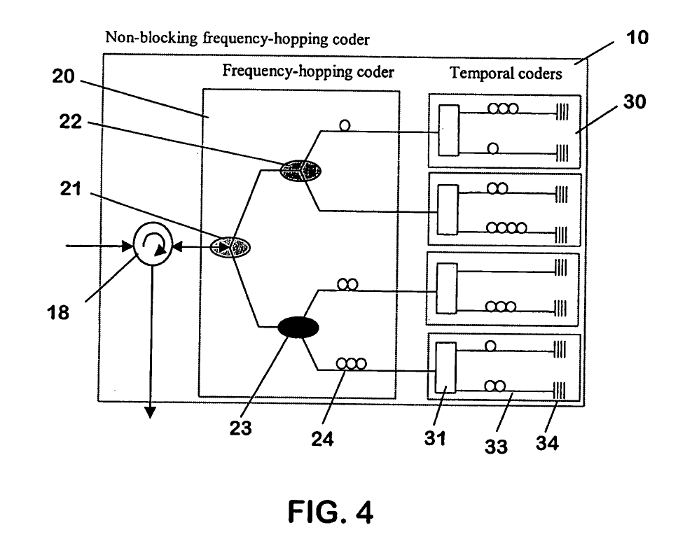

A periodic non-blocking coder 10 using equally a frequency-hopping coder 20 connected to four temporal coders 30 is schematically shown in FIG. 4 as third embodiment of the invention. This embodiment, however, requires only the cascade of interleavers 21-23 integrated in the frequency-hopping coder 20 by making use of reflectors 34.

The non-blocking frequency-hopping coder 10 of the third embodiment comprises a circulator 18 connecting in- and output of the coder to the interleaver 21 of the first stage of the cascade in the frequency-hopping coder 20. As an alternative, the circulator could be replaced by a directional coupler. This adds more loss to the coder and may lead to reflection problems, but is less expensive. Like in FIG. 2, the interleavers 22, 23 of the second stage of the cascade are connected via respective delay lines 24 to the temporal coders 30. In each temporal coder 30, two different delay lines 33 are accessible again via a splitter 32. In contrast to the embodiment of FIG. 2, however, the splitters 32 function at the same time as couplers and the other end of each delay line 33 is terminated within the temporal coders 30 by a reflector 34.

A broadband pulse entering the non-blocking frequency-hopping coder 10 is forwarded by the circulator 18 to the frequency-hopping coder 20, which splits the broadband signal into frequency sets for applying an individual delay to each set as described with reference to FIG. 2. Each delayed frequency set is then split into a pair of identical sets in the respective temporal coder 30 for temporal coding of the set. After having passed the delay lines 33 in the temporal coder 30, the frequency sets of a pair are reflected by the reflector 34 to the splitters/couplers 31, passing the delay lines 33 for a second time. The splitters/couplers 31 combine each pair of frequency sets again to a single, temporally coded frequency set, which is forwarded to the respective delay line 24 of the frequency-hopping coder 20. The frequency sets also pass these delay lines 24 a second time for a second delay, before being combined to a single signal by the cascade of interleavers 21-23.

The resulting signal leaves the frequency-hopping coder 20 and is output by the non-blocking frequency-hopping coder 10 via the circulator 18, which is a direction selective component and therefore able to separate processed signals from incoming pulses.

Since each delay line 24, 33 is passed twice, each delay line 24, 33 of the embodiment of FIG. 4 has to have exactly half the length as compared to the embodiment of FIG. 2 in order to achieve the same coding.

If the temporal coding is realised as coherent temporal coding instead of incoherent coding used in the until now described embodiments, in addition to the shifting of pulses in time, the phase and/or the amplitude of chips can be changed individually within one of a pair of identical frequency bins.

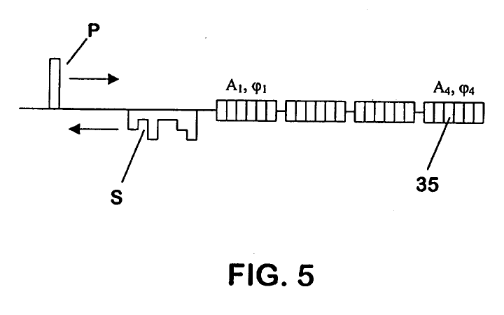

Coherent coding can be achieved for example with fibre Bragg gratings 35 as illustrated in FIG. 5. In the example of FIG. 5, four gratings 35 are applied to an optical fibre. Each of the gratings is composed of a linear array of uniform subgratings. All subgratings have the same grating spacing but different subgrating index amplitudes Aᵢ and spatial phases φᵢ relative to a fixed co-ordinate system. On the left side, a pulse P entering the optical fibre with the fibre Bragg gratings and a coded signal S leaving the optical fibre are shown.

When the depicted short broadband pulse P entering the optical fibre reaches one of the gratings 35, a part of the light is reflected back by each subgrating, resulting in a output signal in form of a train of time-delayed chips S with differing amplitudes, phases and bandwidths. The relative amplitudes, temporal phases, and bandwidths of the chips are determined by the specific amplitude, phase, and length of the individual subgratings comprised by the grating 35. The depicted signal S leaving the optical fibre illustrates the variation in the amplitude over the time.

In a receiving end, a matched grating is used as decoder de-spreading the chips and thereby regenerating the original input pulse. Complete de-spreading of the encoded pulse will only occur if the encoder and decoder gratings are matched. If the codes realised by the fibre Bragg grating are selected in a way that there will be destructive interference between unmatched codes, the MAI will be much lower than in incoherent coding.

Coherent temporal coding can be employed in the coder 10 of FIG. 1, the temporal coder 30 simply constituting a coherent temporal coder.

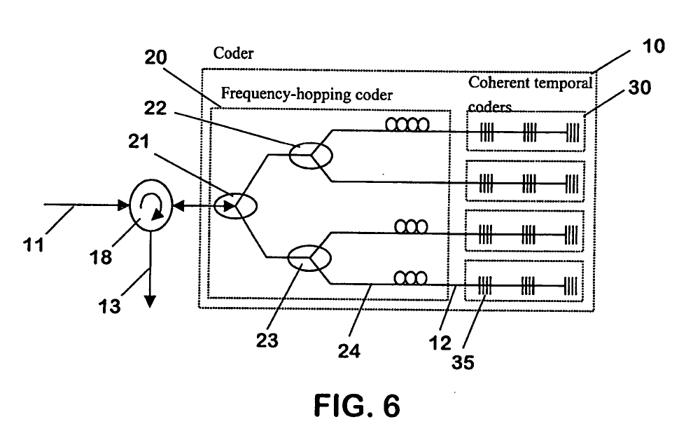

As an alternative, FIG. 6 schematically shows a fourth embodiment of an non-blocking frequency-hopping coder 10 according to the invention, making use of fibre Bragg gratings 35 for coherent temporal coding. Here, a frequency-hopping coder 20 and temporal coders 30 are integrated again in the non-blocking coder 10 as in FIGS. 2 and 4.

A circulator or a directional coupler 18 connects on the one hand an incoming optical fibre 11 and on the other hand an outgoing optical fibre 13 to an in- and output of the complete non-blocking coder 10.

Inside the non-blocking coder 10, the in- and output is connected to a frequency-hopping coder 20 with a cascade of optical interleavers 21-23 and four delay lines 24 in a structure corresponding to the structure of the frequency-hopping coder 20 of the non-blocking coder 10 in FIG. 4.

Each of the four delay lines 24 is connected via fibres 12 arranged outside of the frequency-hopping coder 20 with one of the temporal coders 30, which constitute in this embodiment coherent temporal coders. Each coherent temporal coder 30 is formed by an optical fibre provided with structured fibre Bragg gratings 35 as described with reference to FIG. 5.

A broadband light pulse forwarded to the non-blocking coder 10 via the circulator 18 is divided in the frequency-hopping coder 20 into time-shifted frequency sets as described with reference to FIG. 4.

Each frequency set is then coherently temporally coded in one of the temporal coders 30 as described with reference to FIG. 5. The fibre Bragg gratings of each temporal coder 30 have to be designed to be able to reflect and code at least part of the frequencies of the frequency set with which it is provided by the frequency-hopping coder 20.

The fibre Bragg gratings 35 of the coherent temporal coders 30 reflect the time-spread pulses back to the frequency-hopping coder 20, which collects frequency bin chips from the different delay lines 24. The time-spread encoded signal is separated from the incoming broadband light pulse by the circulator 18 and can now be transmitted along the optical transmission fibre 13 to the receiving end.

At the receiving end, the coded frequency bin chips are decoded in a corresponding non-blocking coder. In this coder, they are first separated by a frequency-hopping coder into different frequency sets and delayed with time-reversed delay lines. Four coherent temporal coders then de-spread each frequency set and thereby regenerate the original frequency bin chips. After a second individual delay of the frequency sets, the frequency-hopping coder combines the frequency sets again, thus forming the original short pulse.

With the fourth embodiment of a coder according to the invention, the interference is reduced as compared to pure frequency coding. In addition, the number of users can be higher as compared to pure coherent coding, since it facilitates a lengthening of the codes.

Each of the four embodiments of non-blocking coders 10 according to the invention can be used equally for encoding and for decoding. For decoding, the applied codes have to correspond reversedly to the codes used for encoding of the input signal.

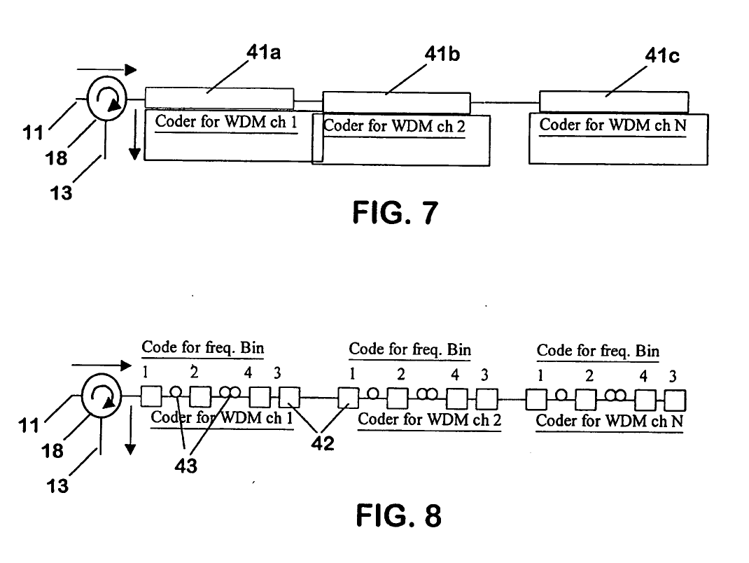

FIG. 7 shows a fifth embodiment of a coder according to the invention. This coder is composed of several separate coherent coders 41a to 41c.

A circulator 18 is connected to two fibres 11, 13 and to a cascade of N coherent coders 41a to 41c, of which only the first two and the N^{th} are shown. Each of the coherent coders 41a to 41c is formed by fibre Bragg gratings as illustrated in FIG. 5. Each coder 41a to 41c is designed to code another one of N different WDM channels ch1-chN.

When a broadband signal arrives via the first one of the fibres 11, it is forwarded by the circulator 18 to the first coder 41a, where a first WDM channel ch1 included in the signal is reflected with different amplitudes and phases as described with reference to FIG. 5. All other WDM channels ch2-chN are passed through to the second coder 41b. The second coder 41b reflects a second WDM channel ch2 included in the signal with different amplitudes and phases and passes through all remaining WDM channels to following coders, each reflecting a specific WDM channel and passing the other received channels through to the next coder until the N^{th} coherent coder 41c is reached. Finally, the N^{th} coder 41c reflects an N^{th} WDM channel chN included in the signal with different amplitudes and phases. The order of the coders provided for the different channels ch1-chN can be chosen arbitrarily.

The reflected WDM channels are forwarded as coded signal by the circulator 18 to the second fibre 13. Because of the coding by reflection, only one direction selective component like a circulator is needed.

FIG. 8 shows a sixth embodiment of a coder according to the invention, which constitutes again a coder composed of several coherent coders, and which can be employed for periodic coherent frequency-hopping coding.

A circulator 18 is connected to two fibres 11, 13 and to a first coherent coder 42. The first coherent coder 42 is connected via a delay line 43, a second coherent coder 42, a further delay line 43 and a third coherent coder 42 to a fourth coherent coder 42. The four coherent coders 42 form together with the delay lines 43 a unit designed for coding four frequency bins of a first WDM channel ch1. The fourth coherent coder 42 is connected to a similar unit of four coders 42 and delay lines 43 designed for coding four frequency bins of a second WDM channel ch2. The second unit is connected via further similar units (not shown), each designed for coding four frequency bins of a specific WDM channel, to an N^{th} similar unit of four coders 42 and delay lines 43 designed for coding four frequency bins of an N^{th} WDM channel chN. All 4*N coherent coders 42 are realised as fibre Bragg gratings as illustrated in FIG. 5. The delays between the coders for the different WDM channels ch1-chN and the order of the coders provided for the different channels ch1-chN can be chosen arbitrarily.

Like in the example of FIG. 7, a broadband signal arriving via the first one of the fibres 11, is forwarded by the circulator 18 to the first unit of coders 42, where a first WDM channel ch1 included in the signal is reflected with different amplitudes and phases. In contrast to FIG. 7, however, each of four frequency bins of the first WDM channel is reflected and thereby coded separately in a dedicated coder 42, each coder reflecting only the respective frequency bin and forwarding the remaining frequency bins of the WDM channel ch1 to the following coder. The second to fourth frequency bins are additionally delayed before reflection by the delay lines 43 they pass. All other WDM channels ch2-chN are passed entirely through to the second unit with the delay caused by the delay lines 43. The four frequency bins of the second to N^{th} WDM channels ch2-chN are coded in the same way by reflection in the second to N^{th} unit of coders 42 and delay lines 43. The reflected signals are delayed again by each delay line 43 they pass on their way back to the circulator 18.

The reflected coded signals are forwarded by the circulator 18 to the second fibre 13.

The coder can have almost the functionality of the coder of FIG. 6, if there are delay lines between the codes, except that different frequency-bins can not be on the same time slot.

In the following, an embodiment of a network architecture employing the method according to the invention will be described.

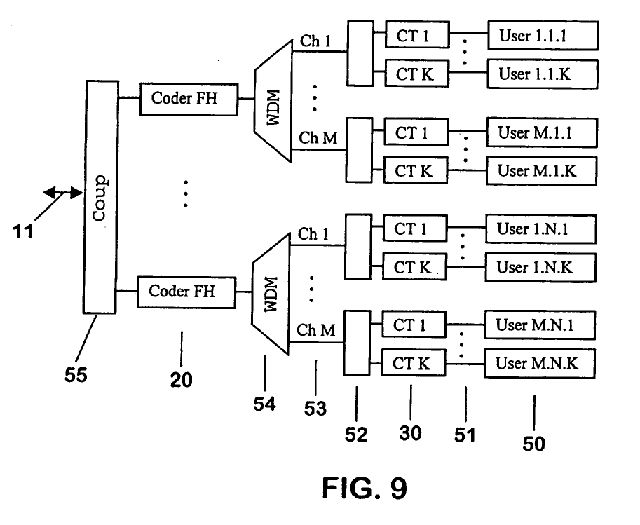

FIG. 9 shows to this end schematically a network architecture for encoding signals originating from a plurality of users 50 for transmission via an optical transmission fibre 11 or for decoding signals arriving via an optical transmission fibre 11 destined for a plurality of users 50.

In the network architecture, a coupler/splitter 55 is connected on the one hand to the optical transmission fibre 11 and on the other hand to N different periodic frequency-hopping coders 20. Each frequency-hopping coder 20 is connected to a WDM multiplexer/demultiplexer 54 which is in addition connected via further fibres 53 to M couplers/splitters 52. Each of these N*M couplers/splitters 52 is connected via K temporal coders 30 to K users. Accordingly, the total number of users is K*M*N. The fibres between the different components can be of unequal lengths. Moreover, the number M of connections 53 between one WDM component 54 and assigned couplers/splitters 52 as well as the number K of temporal coders 30 assigned to one coupler/splitter 52 can vary. The lengths of fiber connecting the different multiplexing stages, i.e. temporal coders, WDM multiplexers and frequency hopping coders, may be different.

If the network architecture is used as transmitting end, the signals from each user 50 are first individually temporally encoded in a dedicated temporal coder 30. Each of the K temporal coders 30 connected to one coupler/splitter 52 is able to apply a different temporal code. Groups of K temporally encoded signals are coupled by one respective coupler 52 to form one channel Ch1-ChM. Since the code of each temporal coder of one group is different, the signals can be differentiated within the combined signal. M different channels Ch1-ChM are multiplexed by one of the WDM multiplexers 54 to a broadband signal. The different channels Ch1-ChM fed to a WDM multiplexer 54 either have already different frequency bands, or the WDM multiplexer 54 filters each channel with a dedicated frequency passband, passing through for this channel only frequencies lying within this passband.

Each combined and temporally coded signal output by one of the N WDM multiplexers 54 is frequency-hopping encoded by a separate periodic frequency-hopping coder 20, each applying a different code. The combination of the codes used by the respective temporal coder 30 and by the respective frequency-hopping coder 20 defines the complete code for a specific user 50. After frequency-hopping coding, all output signals are combined by the coupler/splitter 55 and output to the transmission fibre 11. Since the code of each frequency-hopping coder 20 is different, the signals output by the coders 20 can be differentiated within the combined signal.

If the network architecture is used as receiving end, the processing of signals is exactly reversed. Broadband signals entering the network architecture via the optical transmission fibre 11 are first split into N signals by the splitter 55, then each of the N signals is individually frequency-hopping decoded. Each of the N frequency-hopping decoded signals is demultiplexed by one of the WDM demultiplexers 54 into M channels Ch1-ChM that are fed to one of the M splitters 53 connected to the respective WDM demultiplexer 54. Each splitter 53 splits the received signal into K identical signals for individual temporal decoding by the temporal coders 30. Finally, each of the N*M*K twice decoded signals is provided to one of the N*M*K users 50.

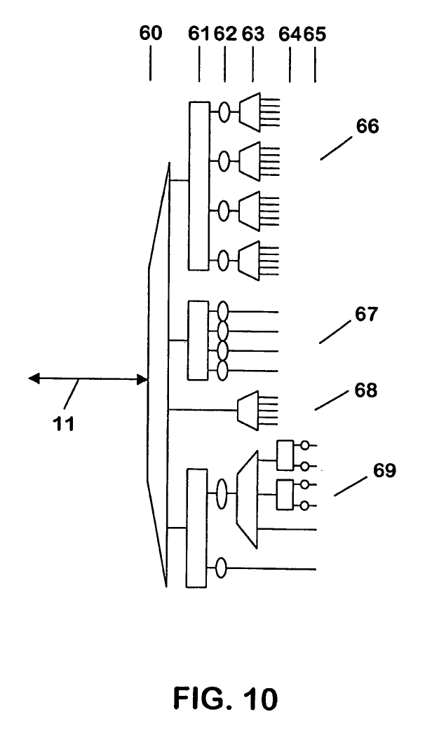

The described network architecture can also be combined with other network architectures in a mixed network architecture, allowing for a very flexible network design. An example for such a mixed network architecture is presented in FIG. 10.

The shown mixed network architecture constitutes a receiving end of an optical transmission network and comprises a band WDM demultiplexer 60. Further components are a plurality of splitters 61, 64, periodic frequency-hopping coders 62, WDM demultiplexers 63, and temporal coders 65. Those further components 61-65 are composed to four different network architectures 66-69, comprising one architecture 69 similar to the architecture of FIG. 9. Further architectures are a WDM PON (passive optical network) or normal PON 68, and pure frequency-hopping coders with optical interleavers 67 as well as an OCDM network architecture based on periodic frequency-hopping coders 66, both described in the above cited document “Optical coder, OCDMA network architecture, and method for optical coding”. The band WDM demultiplexer 60 connects an optical transmission fibre 11 to each of these separate architectures 66-69.

1-47. (canceled)

48. Method for optical coding of a broadband signal comprising coding the broadband signal in sequence in any order temporally and by frequency-hopping,
wherein when said broadband signal is coded by frequency-hopping first, said frequency-hopping coding comprises splitting said broadband signal into at least two distinct frequency sets, each set including at least one frequency bin, each frequency set being coded after said frequency-hopping coding by temporal coding,
wherein when said broadband signal is coded temporally first, said temporal coding of said broadband signal is followed by a frequency-hopping coding, which frequency-hopping coding comprises splitting said temporally coded broadband signal into at least two distinct frequency sets, each set including at least one frequency bin,
and wherein the respective successive application of said temporal coding and said frequency hopping coding to a broadband signal results in temporally individually coded frequency sets.

49. Method according to claim 48, wherein the broadband signal is first coded by frequency-hopping and wherein the frequency-hopping coded signal is further coded temporally.

50. Method according to claim 48, wherein the coding by frequency-hopping and the temporal coding are carried out in sequence but independently from each other.

51. Method according to claim 50, wherein the coding by frequency-hopping is a periodic frequency-hopping comprising before temporal coding demultiplexing the frequency-hopping coded signal into at least two broadband signals of different frequency bands, and wherein each of the at least two broadband signals is coded temporally.

52. Method according to claim 48, comprising:
splitting the broadband signal into at least two frequency bins;
coding each identical frequency bins individually temporally; and
combining the temporally coded frequency bins to a single signal.

53. Method according to claim 52, wherein the individual temporal coding comprises splitting each frequency bin into at least two identical frequency bins, delaying each identical frequency bin individually temporally, and combining each pair of individually delayed identical frequency bins again.

54. Method according to claim 52, wherein the individual temporal coding comprises a serial temporal coding of each frequency bin.

55. Method according to claim 53, wherein the temporally coded frequency bins are reflected and temporally coded again before being combined to a single signal.

56. Method according to claim 52, wherein each frequency bin is individually delayed before being temporally coded.

57. Method according to claim 48, wherein the broadband signal is first coded temporally and wherein the temporally coded signal is further coded by frequency-hopping.

58. Method according to claim 57, wherein the temporal coding and the coding by frequency-hopping are carried out in sequence but independently from each other.

59. Method according to claim 58, wherein several broadband signals are temporally coded individually and multiplexed as signals with different frequency bands to at least one broadband signal for periodic frequency-hopping coding.

60. Method according to claim 48, wherein the frequency-hopping coding is a periodic frequency-hopping coding.

61. Method according to claim 48, wherein the frequency-hopping coding is based on splitting the broadband signal into at least two interleaving frequency sets.

62. Method according to claim 48, wherein the temporal coding comprises a coherent temporal coding.

63. Method according to claim 62, wherein the signals are coded for coherent temporal coding in time and phase and/or amplitude.

64. Method according to claim 62, wherein the coherent temporal coding uses fibre Bragg gratings or superstructured fibre gratings or is based on lattice type coding.

65. Method according to claim 48, wherein the same components are used for bi-directional coding.

66. Optical coder for coding of a broadband signal comprising means for coding a broadband signal by frequency-hopping and means for temporal coding of a broadband signal, both means being connected to each other, said optical coder being operable in at least one of two modes,
wherein in a first one of said two modes, a broadband signal is first coded by said means for frequency-hopping coding, said frequency-hopping coding comprising splitting said broadband signal into at least two distinct frequency sets, each set including at least one frequency bin, each frequency set being coded after said frequency-hopping coding temporally by said means for temporal coding,
and wherein in a second one of said two modes, a broadband signal is first coded temporally by said means for temporal coding, said temporal coding of said broadband signal being followed by a frequency-hopping coding, which frequency-hopping coding comprises splitting said temporally coded broadband signal into at least two distinct frequency sets, each set including at least one frequency bin,
the respective successive employment of said means for coding a broadband signal resulting in both modes in temporally individually coded frequency sets.

67. Optical coder according to claim 66, wherein the means for frequency-hopping coding and the means for temporal coding are separate means.

68. Optical coder according to claim 66, comprising:
as means for frequency hopping coding means for splitting the broadband signal into at least two frequency bins;
as means for temporal coding means for coding each frequency bin individually temporally; and
means for combining the temporally coded frequency bins to a single signal.

69. Optical coder according to claim 66, wherein the means for temporal coding comprise means for coherent temporal coding.

70. Optical coder according to claim 69, wherein the means for coherent temporal coding comprise fiber Bragg gratings.

71. Optical coder according to claim 68, wherein the means for temporal coding comprise means for splitting each frequency bin into at least two identical frequency bins, means for delaying each of the identical frequency bins individually temporally and means for combining the delayed identical frequency bins.

72. Optical coder according to claim 71, comprising reflection means for reflecting the temporally coded signals leaving the means for delaying each of the identical frequency bins individually temporally back via said means to the means for combining the temporally coded frequency bins to a single signal.

73. Optical coder according to claim 68, wherein the means for temporal coding comprise means for serial coding of each frequency bin.

74. Optical coder according to claim 73, comprising reflection means for reflecting the temporally coded signals leaving the means for serial temporal coding back via said means to the means for combining the temporally coded frequency bins to a single signal.

75. Optical coder according to claim 68, further comprising in the means for frequency hopping coding delay lines for delaying each frequency bin individually before forwarding them to the respective means for temporal coding.

76. Optical coder according to claim 68, wherein the means for frequency-hopping coding are means for periodic frequency-hopping coding.

77. Optical coder according to claim 76, wherein the means for periodic frequency-hopping coding are designed in a way that the periodicity is equal to the channel spacing of wavelength division multiplexing components.

78. Optical coder according to claim 76, wherein the means for periodic frequency-hopping coding are designed to code at least one and at the most all of wavelength divisional multiplexing channels destined to be provided to them.

79. Optical coder according to claim 68, wherein the means for frequency-hopping coding comprise at least one interleaver for splitting an incoming broadband signal into at least two interleaving frequency sets.

80. Optical coder according to claim 66, wherein the means for temporal coding are means for periodic temporal coding.

81. Optical coder, comprising a plurality of cascaded coherent coders according to claim 66, wherein each of the cascaded coders is wavelength selective and reflects signals of a corresponding wavelength divisional multiplexing channel back with different amplitudes and phases and passes other wavelength divisional multiplexing channels through.

82. Optical coder according to claim 81, further comprising delay lines between at least some of the cascaded coherent coders.

83. Optical coder, comprising a plurality of cascaded coherent coders according to claim 66, wherein each of the cascaded coders is designed to reflect a specific frequency bin of a specific wavelength divisional multiplexing channel and for passing other wavelength divisional multiplexing channels and other frequency bins of the same wavelength divisional multiplexing channel through, and wherein at least between some of the coherent coders delay lines are provided.

84. OCDMA network for optical coding of broadband signals originating from or destined for a plurality of users, comprising connected between said plurality of users and an optical transmission fibre:
means for temporal coding of optical signals;
means for frequency hopping coding of optical signals, wherein said frequency-hopping coding includes splitting broadband signals into at least two frequency sets, each set including at least one frequency bin; and
means for wavelength division multiplexing or demultiplexing of optical signals;
wherein said means for temporal coding, said means for frequency hopping coding and said means for wavelength division multiplexing or demultiplexing are connected in any order in sequence to each other such that optical signals provided by said plurality of users propagate via said means for temporal coding, said means for frequency hopping coding and said means for wavelength division multiplexing or demultiplexing to said optical transmission fibre, while optical signals provided by said optical transmission fibre propagate via said means for temporal coding, said means for frequency hopping coding and said means for wavelength division multiplexing or demultiplexing to said plurality of users, each of said means for temporal coding, said means for frequency hopping coding and said means for wavelength division multiplexing or demultiplexing processing received optical signals, the subsequent employment of said means for temporal coding and said means for frequency hopping coding resulting in temporally individually coded frequency sets.

85. OCDMA network according to claim 84, wherein said means for temporal coding, said means for frequency hopping coding and said means for wavelength division multiplexing or demultiplexing constitute means for optical encoding of broadband signals originating from a plurality of users, wherein said means for temporal coding are means for temporal encoding of optical signals originating from the plurality of users and for forwarding the temporally coded signals in direction of the optical transmission fibre, wherein said means for frequency hopping coding are means for frequency hopping encoding of optical signals originating from the plurality of users and for forwarding the frequency hopping coded signals in direction of the optical transmission fibre, and wherein said means for wavelength division multiplexing or demultiplexing are means for wavelength division multiplexing of optical signals originating from the plurality of users and for forwarding the multiplexed signals in direction of the optical transmission fibre.

86. OCDMA network according to claim 85, comprising:
separate means for temporal coding for each user;
at lest one means for multiplexing the temporally coded signals of at least part of the users with different frequency bands to a single signal;
assigned to each means for multiplexing a means for periodic frequency hopping coding for coding the respective multiplexed signal with a different code.

87. OCDMA network according to claim 86, wherein the at least one means for multiplexing comprises a plurality of means for multiplexing each multiplexing the temporally coded signals of a different group of users, wherein the at least one means for periodic frequency hopping coding comprises a separate means for periodic frequency hopping coding for each means for multiplexing, and wherein means are provided for combining the plurality of frequency hopping coded signals output by the plurality of means for frequency-hopping coding to a single signal.

88. OCDMA network according to claim 86, comprising at least one means for coupling the temporally coded signals of at least two of the users before multiplexing, the means for temporal coding for the respective at least two users applying different codes.

89. OCDMA network according to claim 84, wherein said means for temporal coding, said means for frequency hopping coding and said means for wavelength division multiplexing or demultiplexing constitute means for optical decoding of an encoded broadband signal destined for a plurality of users, wherein said means for temporal coding are means for temporal decoding of signals originating from the optical transmission fibre and for forwarding the temporally decoded signals in direction of the plurality of users, wherein said means for frequency hopping coding are means for frequency hopping decoding of signals originating from the optical transmission fibre and for forwarding the frequency hopping decoded signals in direction of the plurality of users, and wherein said means for wavelength division multiplexing or demultiplexing are means for wavelength division demultiplexing of the signals originating from the optical transmission fibre and for forwarding the demultiplexed signals in direction of the plurality of users.

90. OCDMA network according to claim 89, comprising:
at least one means for periodic frequency hopping decoding for decoding the encoded broadband signal by frequency hopping;
assigned to each means for periodic frequency hopping decoding means for demultiplexing the frequency-hopping decoded signal into at least two signals with different frequency bands;
means for temporal decoding of each signal output by the means for demultiplexing, and for forwarding each temporally decoded signal to one of the users.

91. OCDMA network according to claim 90, wherein the at least one means for periodic frequency hopping coding comprises a plurality of means for periodic frequency hopping coding each decoding by frequency hopping a part of the encoded broadband signal, wherein the at least one means for demultiplexing comprises a separate means for demultiplexing for each means for periodic frequency hopping coding, and wherein means for splitting the encoded broadband signal are provided for feeding a part of the encoded broadband signal to each of the plurality of means for frequency hopping coding.

92. OCDMA network according to claim 90, comprising means for splitting at least one of the signals output by the means for demultiplexing into at least two signals, and comprising means for temporal coding suited for coding each of the signals resulting from the same signal output by the means for demultiplexing with different codes.

93. OCDMA network according to claim 85, wherein the comprise elements are suited to be used in opposite direction for decoding encoded broadband signals destined for a plurality of users.

94. OCDMA network according to claim 89, wherein the comprised element are suited to be used in opposite direction for encoding of broadband signals originating from a plurality of users.
